(19) United States
(12) Patent Application Publication
(10) Pub. No.: US 2005/0031746 A1
(43) Pub. Date: Feb. 10, 2005

(54) Motion picture candy

(76) Inventor: Richard Johnson, San Diego, CA (US)

Correspondence Address: Burkhart & Burkhart, 940 Dakota Avenue, Whitefish, MT, 59937, US

(21) Appl. No.: 10/883,911

(22) Filed: Jul. 2, 2004

Related U.S. Application Data
(60) Provisional application No. 60/484,497, filed on Jul. 2, 2003.

(51) Int. Cl. A23P 1/00

(52) U.S. Cl. 426/383

(57) ABSTRACT

An edible confection assembly includes a holder including a rotatable spool. At least one layer of edible material is wrapped around the spool. A series of images is formed on the edible material, the series of images being sequenced such that serial viewing of the images creates a motion picture effect. A rotation mechanism is secured to the spool, the rotation mechanism being adapted and constructed to impart rotation to the spool.

### CROSS-REFERENCE TO RELATED APPLICATIONS

None

### STATEMENT AS TO RIGHTS TO INVENTIONS MADE UNDER FEDERALLY-SPONSORED RESEARCH AND DEVELOPMENT

None

### FIELD OF THE INVENTION

The invention relates generally to combination novelty confections, specifically interactive novelty confections with the ability to display animated motion pictures embedded and layered in candy.

### DESCRIPTION OF RELATED ART

This invention is an edible motion picture display assembly. There a few things that spark the imagination like motion pictures, or satisfy taste buds like candy. Over the last hundred or so years, there have been many variations regarding the design and implementation of motion picture devices. Most notably are movie projectors, but there have also been small devices, and even some of them mechanically reeled by hand, and other mechanical motion picture viewing devices known as zoetrope's that use spinning trays with pictures. In today's digital age there are numerous ways to experience movies including computers, laptop computers and even handheld “PalmPilot Computers.” One of the newer non-electric motion picture animation concepts is Newmann, U.S. Pat. No. 5,528,324. Newman utilizes paper wound up in a horizontal reel fashion. The perception of animation is created by watching the pictures drop from the reel in succession utilizing gravity.

Regarding the edible confection aspect of the assembly, there have been a number of attempts at interactive novelty candy holders and assemblies, such as U.S. Pat. No. 5,471,373 to Coleman, et al. The Coleman patent is directed to a candy sucker holder entertainment device but does not address motion pictures or animation.

Another example is Plante, U.S. Pat. No. 6,471,364. The Plante patent is directed to a chemiluminescent candy holding device. The device includes a cylinder attached to a translucent or transparent lollipop. The assembly requires shaking in order to activate a chemiluminescent mixture thus lighting the confection and holder stem.

There is a significant degree of amusement value provided in the devices described in these patents. However, it will be apparent to those of skill in the art, that none address the combination of a motion picture viewing device with edible confections. Additionally, known devices related to motion pictures or interactive confections fail to accomplish the outcome described herein. It is anticipated that the extended features and utilities of assembling a motion picture viewing device made out of candy could greatly enhance the commercial versatility of such viewing device. It can be seen from the foregoing that the need exists for an interactive edible movie viewing device that overcomes the shortfalls of known arrangements in this technology.

### SUMMARY

In accordance with the principles of the present invention, a combination novelty edible confection motion picture viewing assembly is disclosed. An edible confection assembly includes a holder including a rotatable spool. At least one layer of edible material is wrapped around the spool. A series of images is formed on the edible material, the series of images being sequenced such that serial viewing of the images creates a motion picture effect. A rotation mechanism is secured to the spool, the rotation mechanism being adapted and constructed to impart rotation to the spool.

The edible motion picture viewing assembly preferably includes a cylindrical rolled block of spooled multilayered confections combining translucent and opaque candy, layered with edible printed rice paper, or other such suitable printed material, and pictures arranged frame by frame in the linear or circular fashion, with an axle to allow the rotation of the cylindrical rolled block, and a handle with an independent movie frame viewing window attached thereto.

The combination assembly is adapted and constructed to provide a means to view animated motion pictures embedded within layers of candy. There are several designs, each with different mechanisms. One embodiment of the invention is designed to utilize a wheel shaped confection constructed from one long strip of multilayered candy approximately the shape of a hockey puck. The wheel shaped candy block contains a hole through the center to allow an axle insertion for spinning the block. The axle may optionally contain a gear assembly to maintain a specific RPM rate for optimizing motion picture viewing. Additionally the rotational axle gear assembly may be activated by a motor, hand activated crank, or other means to initiate rotational motion upon the cylindrical wheel shaped block of multilayered candy.

Another design utilizes independent layers of film/candy strategically placed one inside the other as opposed to one long piece of multilayered candy rolled up. In this embodiment of the user will experience eating one film layer at a time without disrupting the linear film sequence.

Another embodiment utilizes a barbershop pole type/tube design wherein the candy spins and the viewing window adjusts up and down the candy pole. After the user has viewed the film clips available on the first layer up and down, they may lick to reveal the next layer and so forth.

In another embodiment motion pictures are sequentially placed on the flat sides of the multilayered candy block and layered upon one another. The motion picture viewing window slides on the radius of the wheel shaped block of candy. By adjusting and moving the viewing window, users can view the pictures much like a rotational View-Master picture viewer.

In another embodiment the individual frames are miniaturized pages from a book, magazine, paragraphs, or pictures such as children's stories that can be read utilizing the magnified viewing window—one frame a time. Viewers see each frame for a particular layer, and then lick the candy down to the next layer and so on.

In another embodiment, the individual frames are printed on a continuous length or individual lengths of chewing gum which are wrapped around an axle, to form a wheel block shape.

In addition to the entertainment value of the present invention, there are other aspects as well. The multilayered candy could be utilized for advertising, promotional uses, games, contests, candy layers containing print such as books and other novelty printed items revealed frame by frame, one layer at a time, and even treasure hunts.

The invention itself, however, both as to organization and method of operation, together with further objects and advantages thereof, may be best understood by reference to the following description taken in conjunction with the accompanying drawings.

### BRIEF DESCRIPTION OF THE DRAWINGS

FIG. 1 is a schematic view of a candy wheel block and the wheel with an axle and handle in accordance with the principles of the present invention.

FIG. 2 illustrates motion picture candy wheel with viewing window apparatus

FIG. 3 illustrates motion picture candy wheel with viewable layer frame by frame pictures

FIG. 4 illustrates additional view window blocking flaps and film reel graphic on the flat side of the block

FIG. 5 illustrates alternative picture frame placements and confectionary shapes

FIG. 6 illustrates preferred embodiment of confectionary layers

### DETAILED DESCRIPTION OF PREFERRED EMBODIMENTS

While this invention is susceptible of embodiment in many different forms, there is shown in the drawings, and will herein be described in detail, exemplary embodiments, with the understanding that the present disclosure is to be considered as illustrative of the principles of the invention and not intended to limit the invention to the exemplary embodiments shown and described.

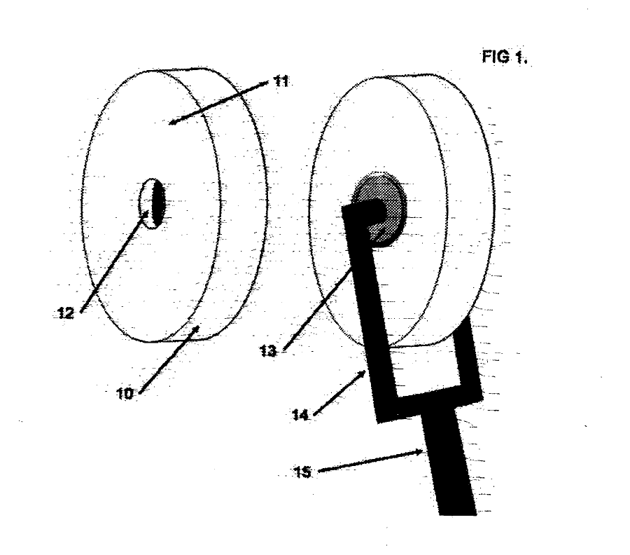

FIG. 1. Represents three-dimensional views of the edible confection motion picture viewer, with and without handle assembly. The leading edge continuous round layer 10 represents one or more layers wrapped and spooled, extending from the center. The layers are wrapped around a supportive axle mount center 12, located in the center of the wheel block. 11 flat side wall, may contain printing or layers in other embodiments. 13 axle assembly may optionally contain gear assembly for frame rate RPM stabilization. 14 handle fork which optionally oscillates in and out of axle moving screw mesh axle assembly creating stabilized rotational force on the wheel actualized with a squeeze motion from the handle, hand twirl, or motor. A handle 15, preferably hollow, may optionally contain electronics, integrated circuitry for audio reproduction, electronic motor and circuitry, batteries and other motion picture viewing support materials including spare parts, a light source, confections, instructions, printed materials, or digital storage.

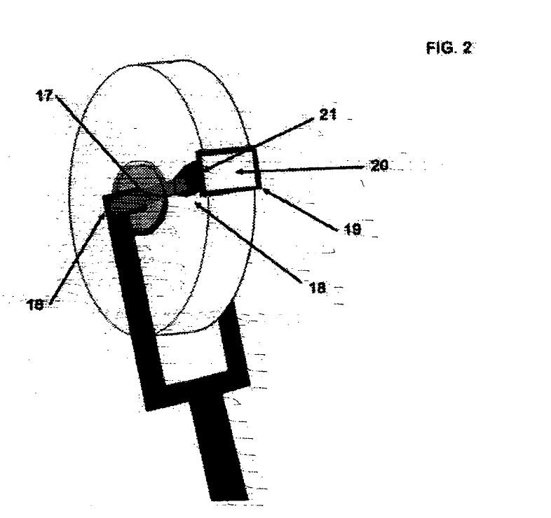

FIG. 2. represents a motion picture candy wheel with viewing window apparatus. 16, is the hole slot in the fork assembly which enables the window viewing arm rod 17, to slide into the fork assembly allowing the viewing window to adjust positions in relation to the consumption of the layers of confection. Further 16 may include a locking pin assembly to stabilize the position of the viewing window arm rod 17. The viewing window arm rod slides and adjusts into the axle/fork mounting hole 16, and also allows the viewing window to pivot into and out of position. Viewing window arm rod 17, may optionally contain a lightbulb or LED to enhance viewing light to window 20. Viewing window pivot joint 18, connects to 17, with a pin or snap assembly allowing the viewing window 20, to be optimally positioned. 18, may also contain reflective interior means to direct light source to the viewing window 20. Viewing window frame 19, connected to 18, holds and secures viewing window 20. Viewing window 20 preferably a magnifying window lens for viewing frames. Optional flicker rate circuitry or switch 21, turns light on/off in time with specified RPM utilized to enhance frame movement illusion, and may also operate a shutter on the viewing window.

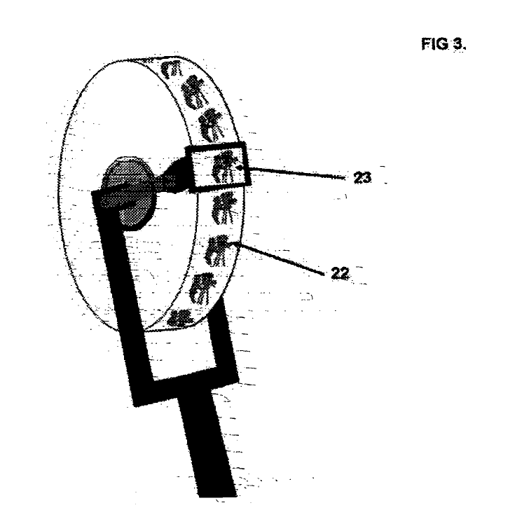

FIG. 3. illustrates motion picture candy wheel with viewable confection layer containing frame by frame pictures. Sequential pictures 22, are rotated into and out of view window. Individual focused frame 23, may be statically viewed individually, a still shot, or as part of an animated action motion picture sequence.

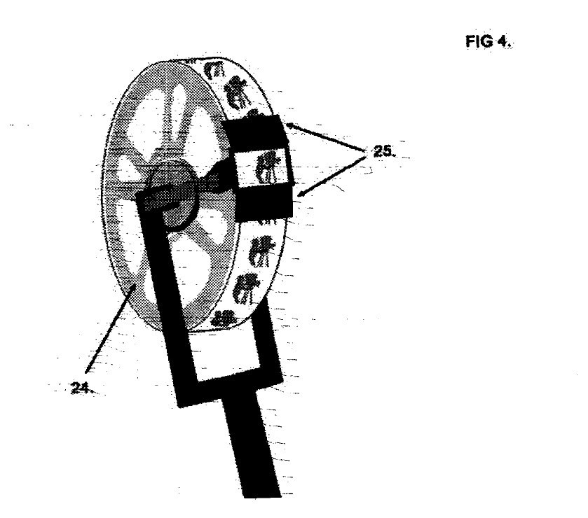

FIG. 4. illustrates additional view window blocking flaps 25, and a film reel graphic 24, on the flat side of the confection wheel block. View window blocking flaps 25, help draw visual focus and attention away from rotational motion of candy wheel block, as well as shade out unwanted glare from external light sources, and sun light. The flat side film reel graphic 24, represents a graphic tone or logo for the product as relates to motion pictures. The graphic could optionally be any image, advertisement, logo, art or picture.

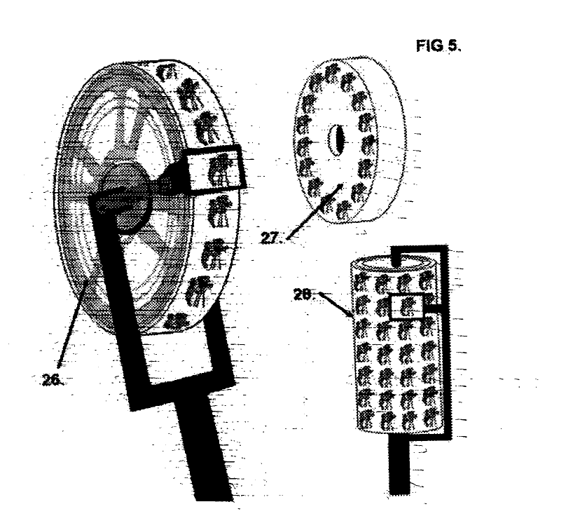

FIG. 5. Illustrates alternative embodiments, picture frame placements and confectionary shapes. Confectionary layers 26, are illustrated here as independent layers placed one inside the other. The confectionary layers 26, could also be produced as one long continuous sheet rolled on a spindle axle. Side mount picture view layer 27, is an alternative to the spooled layer wrapping previously mentioned. In this embodiment 27 represents layers of confection stacked one on top of another with the viewing taking place on the side of the confection instead of the round continuous wheel part. Rollup or tube embodiment 28, is represented as an additional potential embodiment wherein layers are wrapped in a tubular fashion with a vertically or horizontally positional adjusting view window assembly.

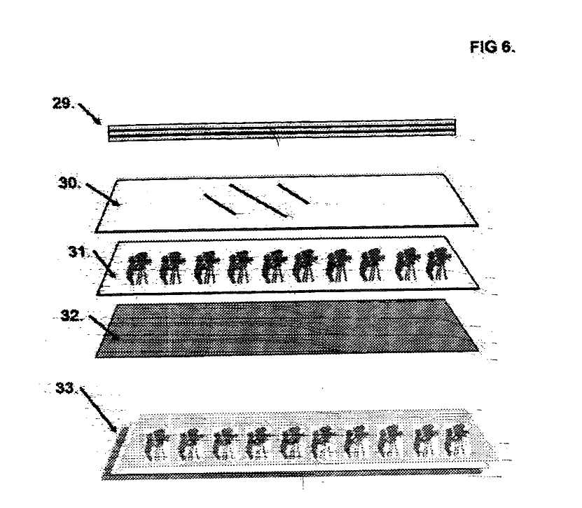

FIG. 6. Illustrates preferred embodiment of confectionary layers. Side view of stacked confectionary layers 29, shows a side view layers that have been stacked and pressed into position. Transparent top layer 30, protects film layer 31, which is backlit and secured by opaque back layer 32. 33 shows the layers slightly offset with the movie layer 31, seen through the transparent top layer 30. It is anticipated that the preferred embodiment of the film layer, 31 will be made of printed rice paper, or another embodiment could call for inedible food grade papers or films. The embedded inedible films or papers may be saved as collectibles retrieved by eating through layers of edible confection.

The foregoing is merely exemplary of the concept of an edible motion picture viewing assembly. In another context, regarding a partially edible motion picture viewing assembly, there are several potential variations in which the user can interact with the printed materials, films or papers as collectibles.

While details of the invention are discussed herein with reference to some specific examples to which the principles of the present invention can be applied, the applicability of the invention to other devices and equivalent components thereof will become readily apparent to those of skill in the art. For example, games can be incorporated using the layers to create clues and find hidden treasures embedded within various layers. Individual frames can provide instruction for schoolchildren, including math, science, history and even entire books can be miniaturized and printed on layers viewed one frame the time, and seen through a magnifying viewing lens. Further, there are an unlimited variety of patterns and art that can be created and manipulated utilizing the preferred embodiments disclosed herein.

Accordingly, it is intended that all such alternatives, modifications, permutations, and variations to the exemplary embodiments can be made without departing from the scope and spirit of the present invention.

1. An edible confection assembly comprising the following:
a holder including a rotatable spool;
at least one layer of edible material wrapped around the spool;
a series of images on the edible material, the series of images being sequenced such that serial viewing of the images creates a motion picture effect; and
a rotation mechanism secured to the spool, the rotation mechanism being adapted and constructed to impart rotation to the spool.

2. An edible confection assembly in accordance with claim 1, further comprising a light source directed on the images.

3. An edible confection assembly in accordance with claim 1, further comprising a viewing window.

4. An edible confection assembly in accordance with claim 1, wherein the rotation mechanism comprises a motorized rotation mechanism.
